(19) United States
(12) Patent Application Publication
(10) Pub. No.: US 2009/0290714 A1
(43) Pub. Date: Nov. 26, 2009

(54) Protocol for Verifying Integrity of Remote Data

(75) Inventors: Denis X. Charles, Redmond, WA (US); Kristin E. Lauter, La Jolla, CA (US); Anton Mityagin, La Jolla, CA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/123,688

(22) Filed: May 20, 2008

(51) Int. Cl. H04L 9/08

(52) U.S. Cl. 380/278

(57) ABSTRACT

An exemplary method for verifying the integrity of remotely stored data includes providing a key; providing a fingerprint, the fingerprint generated using the key in a keyed cryptographic hash function as applied to data of known integrity; sending the key to a remote storage location that stores a copy of the data of known integrity; receiving a fingerprint from the remote storage location, the fingerprint generated using the key in a keyed cryptographic hash function as applied to the remotely stored copy of the data; and verifying the integrity of the remotely stored copy of the data based at least in part on comparing the provided fingerprint to the received fingerprint. Other exemplary methods, systems, etc., are also disclosed.

### BACKGROUND

Many reasons exist to store data remotely. For example, requirements to backup data off-site, requirements to have the same data readily accessible to multiple offices, etc. In addition, some of the emerging so-called Web 2.0 distributed applications require users to store data remotely. However, in all of these scenarios significant issues arise when one wants to check the integrity of remotely stored data. Conventional approaches access the remote storage location and then request transmission of the data. Once the remotely stored data is received, a user then compares the received data to data of known integrity (e.g., the original data or a verified copy of the original). In the context of distributed applications with a web interface and a remote data store, the bandwidth for the remote data store may be limited. Hence, when many users want to check the integrity of their data (e.g., on some “standard”, regular basis), the bandwidth requirements soar as large quantities of data are accessed and transmitted. While various issues have been presented in the context of Web 2.0, other issues exist in this and other contexts. The description that follows identifies additional issues and presents an exemplary protocol that can allow for efficient verification of remotely stored data.

### SUMMARY

An exemplary method for verifying the integrity of remotely stored data includes providing a key; providing a fingerprint, the fingerprint generated using the key in a keyed cryptographic hash function as applied to data of known integrity; sending the key to a remote storage location that stores a copy of the data of known integrity; receiving a fingerprint from the remote storage location, the fingerprint generated using the key in a keyed cryptographic hash function as applied to the remotely stored copy of the data; and verifying the integrity of the remotely stored copy of the data based at least in part on comparing the provided fingerprint to the received fingerprint. Other exemplary methods, systems, etc., are also disclosed.

### DESCRIPTION OF DRAWINGS

Non-limiting and non-exhaustive examples are described with reference to the following figures:

FIG. 1 is a diagram of a conventional system for verifying the integrity of remotely stored data;

FIG. 2 is a diagram of an exemplary system for verifying the integrity of remotely stored data;

FIG. 3 is a block diagram of an exemplary method for verifying the integrity of remotely stored data;

FIG. 4 is a block diagram of various components associated with parties that participate in a system for remote storage of data and verification of such data;

FIG. 5 is a diagram of an exemplary system, optionally a peer-to-peer system, for remote storage of data and verification of such data; and

FIG. 6 is a block diagram of an exemplary computing device.

### DETAILED DESCRIPTION

Various exemplary methods, devices and systems described herein pertain to verifying the integrity of remotely stored data. An exemplary protocol provides for efficient integrity checks and allows for formation of efficient systems such as peer-to-peer systems where peers can backup each other's data and verify the integrity of the backup data without requiring transmission of the backup data. As explained below, with reference to the drawings, an exemplary protocol includes transmission of a key and receipt of a fingerprint where the fingerprint is generated at least in part on the key and at least in part on the remotely stored data that is undergoing an integrity check. This protocol can be implemented in any of a variety of manners and systems. To understand better issues confronting conventional systems, a typical conventional system is described followed by an exemplary system that uses such an exemplary key/fingerprint-based protocol.

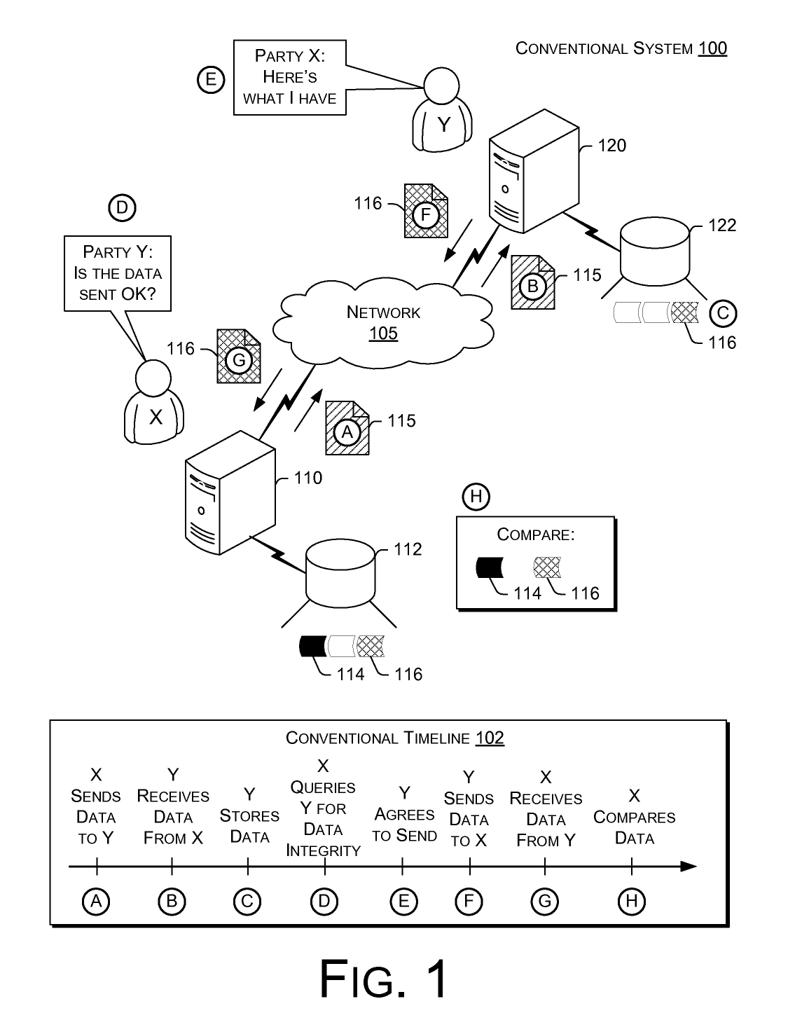

FIG. 1 shows a conventional system 100 and associated timeline 102 for verifying integrity of remote data. The system 100 includes a “local” party X with an associated computer 110 and data store 112 for storing data. The system 100 also includes a “remote” party Y with an associated computer 120 and data store 122 for storing data. A network 105 allows for communications to occur between the computer 110 of party X and the computer 120 of party Y.

The timeline 102 shows various steps that typically occur in a convention method for verifying integrity of remote data. At step A, party X generates, from data 114, a copy 115 and sends the copy 115 to party Y. At step B, party Y receives the copy 115 as transmitted via the network 105. In performing steps A and B, the integrity of data 114 may be compromised. For example, the copy 115 may lack integrity and/or the transmission via the network 105 may corrupt the copy 115. While the latter type of corruption may occur, in the example of FIG. 1, for simplicity, the data 115 is represented as being sent and received without corruption.

After party Y receives the data 115, at step C, the data 115 is stored at the data store 122 as data 116. Data 116 represents data that may, initially, have integrity or not, for example, by a write error or other error. Alternatively, over time, some process may occur that affects the integrity of the data 116 such that it no longer represents an accurate copy of the data 114.

According to step D, party X wants to verify the integrity of the data sent to part Y. This query may occur in any of a variety of manners. For example, party X may call party Y, email party Y, or take some other action that prompts party Y to respond to the query. At step E, party Y responds to party X by agreeing to send a copy of its stored data 116.

In this example, one or more errors may occur in making a copy of the stored data 116. Further, at steps F and G, where party Y sends the copy of its stored data 116 to party X and where party X receives and stores the copy of the stored data 116, respectively, additional errors may occur that corrupt the copy of the stored data 116. For example, some of “errors” may be malicious corruption of the data caused by party Y.

At step H, party X performs a comparison to compare the data 116 as received from party Y to its data 114. While this comparison aims to verify the integrity of the data stored remotely, as explained, it can be fraught with issues that can confound verification. Such issues can be compounded when the data to be verified is, for example, a large file (e.g., more opportunities for read/write errors, transmission errors, etc.).

In the example of FIG. 1, party X may be deemed the data “owner”. While this example shows party X performing the verification of the remote data, in an alternative, party X could delegate this responsibility or task to a third party. However, such delegation would not resolve the nature or number of issues that may occur. Indeed, such delegation is likely to make verification even more prone to error.

As yet another alternative, party X may be the owner of the data 114 yet store the data at a third party storage provider. Regardless of configuration, issues exist when transmission of the data is required to perform a comparison for purposes of verifying integrity of the data.

Another scenario exists in many peer-to-peer environments. For example, in a peer-to-peer environment user machines (peers) may store data that “belongs” to (i.e. is owned by) one or more other users. In such an example, communication of copies of remote data for purposes of verifying integrity of the remote data can be cumbersome and expensive, as well as detrimental to performance of the peer-to-peer network and user experience.

Yet another scenario exists where one stores a large amount of data on a remote storage provider such as Amazon S3 service. In such a scenario, data communication can be expensive. Hence, it is undesirable to transmit copies of remote data for purposes of verifying integrity of the remote data.

As described herein, an exemplary protocol overcomes various issues associated with the system 100 of FIG. 1 and/or one or more of the aforementioned scenarios. Specifically, an exemplary protocol allows data owners to verify integrity of such remotely stored data. Furthermore, a data owner can delegate integrity checking capabilities to a third party. Such an exemplary protocol can be used by a number of peer-to-peer applications.

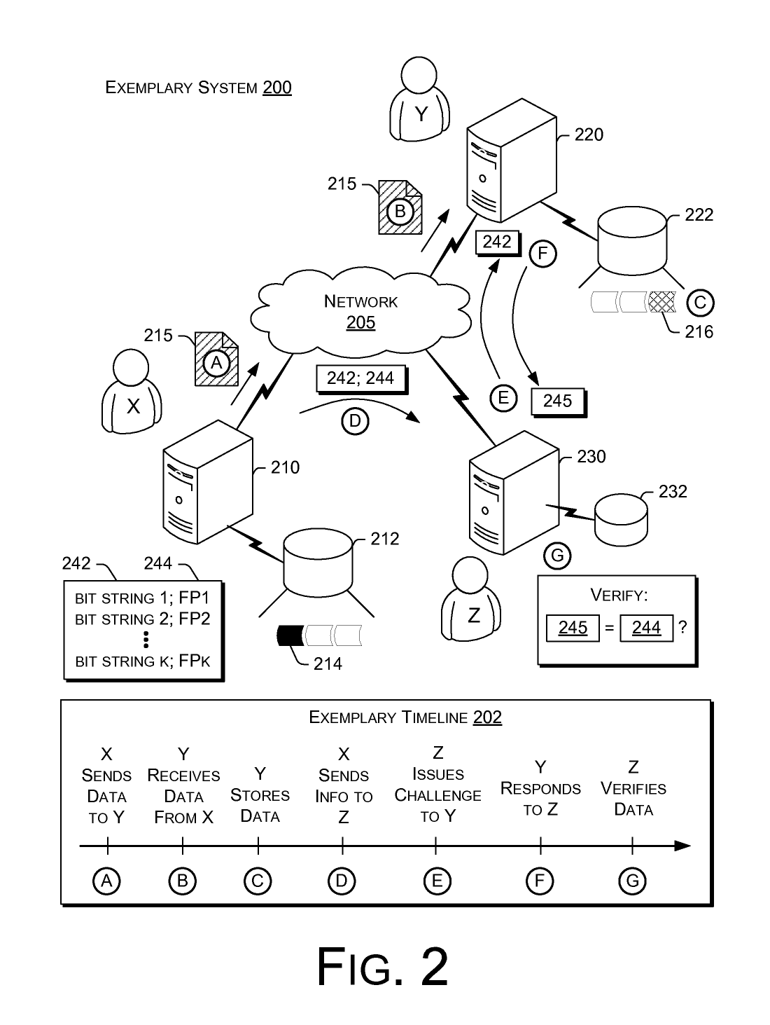

FIG. 2 shows an exemplary system 200 that includes three parties to illustrate operation of an exemplary protocol along a timeline 202. As shown in FIG. 2, the system 200 includes a data owner as party X with an associated computer 210 and data store 212 for storing data, a storage provider as party Y with an associated computer 220 and data store 222 for storing data and a validator as party Z with an associated computer 230 and a data store 232 for storing information for verifying data. A network 205 allows for communications to occur between the computer 210 of party X, the computer 220 of party Y and the computer 230 of party Z.

In the scenario of FIG. 2, the storage provider Y is supposed to securely store data obtained from data owner X and the validator Z needs to be able to efficiently verify that the storage provider Y has an accurate (e.g., exact) copy of the data obtained from data owner X without having to transfer any significant portion of the data. The data owner X and the validator Z can either be the same user or distinct users. For example, in the conventional system 100 of FIG. 1, the party X is described as being the data owner and the validator (i.e., the party that ultimately verifies integrity of the data).

The timeline 202 shows various steps that typically occur in an exemplary method for verifying integrity of remote data that relies on an exemplary protocol. At step A, party X generates, from data 214, a copy 215 and sends the copy 215 to party Y. At step B, party Y receives the copy 215 as transmitted via the network 205. In performing steps A and B, the integrity of data 214 may be compromised. For example, the copy 215 may lack integrity and/or the transmission via the network 205 may corrupt the copy 215. While the latter type of corruption may occur, in the example of FIG. 2, for simplicity, the data 215 is represented as being sent and received without corruption.

After party Y receives the data 215, at step C, the data 215 is stored at the data store 222 as data 216. Data 216 represents data that may, initially, have integrity or not, for example, by a write error or other error. Alternatively, over time, some process may occur that affects the integrity of the data 216 such that it no longer represents an accurate copy of the data 214.

In various scenarios, data may be corrupted intentionally by party Y or someone who maliciously attacks party Y. In a scenario that may lack serious intent to harm a data owner, part Y may simply desire more memory (e.g., hard drive space) to store its own data. As explained, an exemplary scheme requires party Y to have a copy of the data that has integrity. This prevents party Y from responding with, for example, random bytes to mimic integrity or existence of the stored data.

In FIG. 2, the steps A, B and C are essentially the same as those that occur in conventional timeline 102 of FIG. 1. However, steps that follow differ as they rely on an exemplary protocol that can eliminate various issues that exist in the system 100 of FIG. 1.

According to the timeline 202, at step D, which may occur prior to sending the data 215 from party X to party Y, party X sends information 242, 244 to party Z, the validator, for use in validating or verifying integrity of data stored remote from party X (i.e., the computer 210 and data store 212). According to an exemplary protocol, the information 242 is one or more bit strings (e.g., 1, 2, . . . , k, where k>0) and the information 244 is a fingerprint generated at least in part from one of the bit strings; noting that in some instances, a fingerprint may be generated from more than one bit string. A bit string may be generated, for example, using a random number generator or pseudo-randomly using a master key. In the example of FIG. 2, each of the k bit strings 242 (where k>0) is used as a key for a keyed cryptographic hash function where the hash function is then applied to data to generate a corresponding fingerprint and, in total, k fingerprints 244.

At step E, which occurs at some time (or times) after step C, party Z issues a challenge to party Y by sending one or more of the bit strings 242 to party Y. Such a communication may occur via the network 205 or by other means (e.g., a secure line, a dedicated line, etc.). At step F, party Y responds to the challenge by generating one or more fingerprints 245 based on the one or more received bit strings 242 (e.g., using a keyed cryptographic hash function and the computer 220) and its stored data (e.g., the stored data owned by a remote party), and then sending the one or more fingerprints 245 to party Z.

At step G, party Z verifies the one or more fingerprints 245 received from party Y, for example, by comparing them to the appropriate one or more fingerprints 244 as received from party X.

Hence, in system 200, the exemplary protocol requires no transmission of the remotely stored data to verify the integrity of the data. Instead, it requires a computational step to generate at least one fingerprint based on a challenge (e.g., a bit string that is a key for a keyed cryptographic hash function).

As a single bit string and fingerprint can be quite small compared to the size of data to be verified, the communication can occur efficiently with little overhead. Further, such communication may occur over any of a variety of communication paths such as a dedicated phone line, etc., where bandwidth is limited.

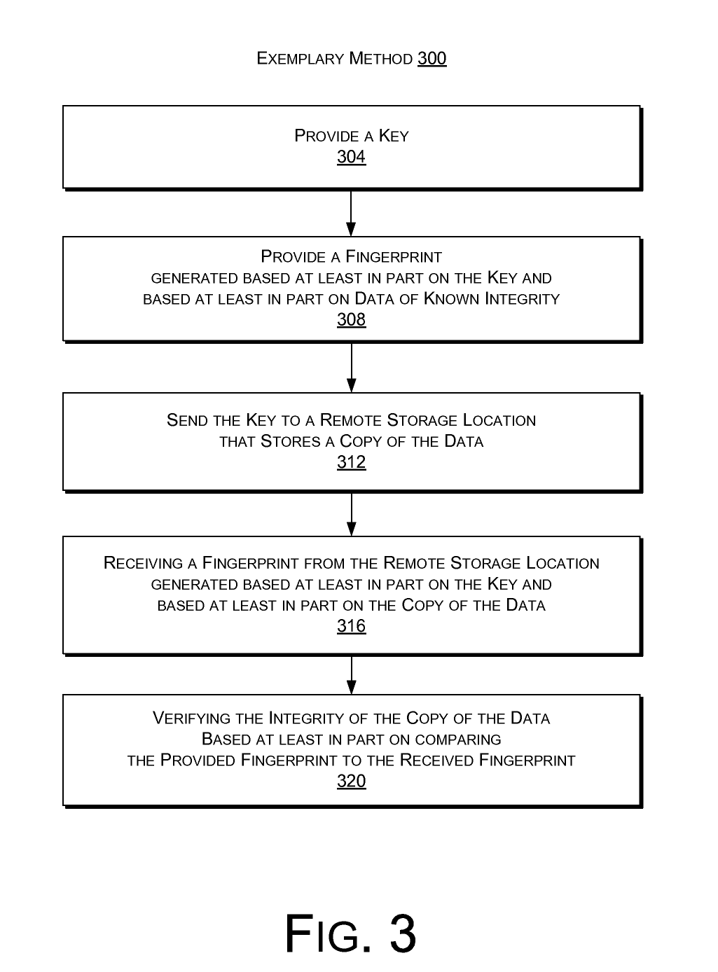

FIG. 3 shows an exemplary method 300 for verifying the integrity of remotely stored data. In a provision block 304, a key is provided. In another provision block 308, a fingerprint is provided where the fingerprint is generated using the key in a keyed cryptographic hash function as applied to data of known integrity. While the blocks 304 and 308 are shown as separate blocks, these actions may occur in a single provision block that provides one or more key/fingerprint pairs. In a send block 312, the key is sent to a remote storage location that stores a copy of the data of known integrity. A receipt block 316 receives a fingerprint from the remote storage location where the fingerprint is generated using the key in a keyed cryptographic hash function as applied to the remotely stored copy of the data. A verification block 320 verifies the integrity of the remotely stored copy of the data based at least in part on comparing the provided fingerprint to the received fingerprint. In such a manner, the integrity of remotely stored data may be verified without requiring transmission of the data from the remote storage location.

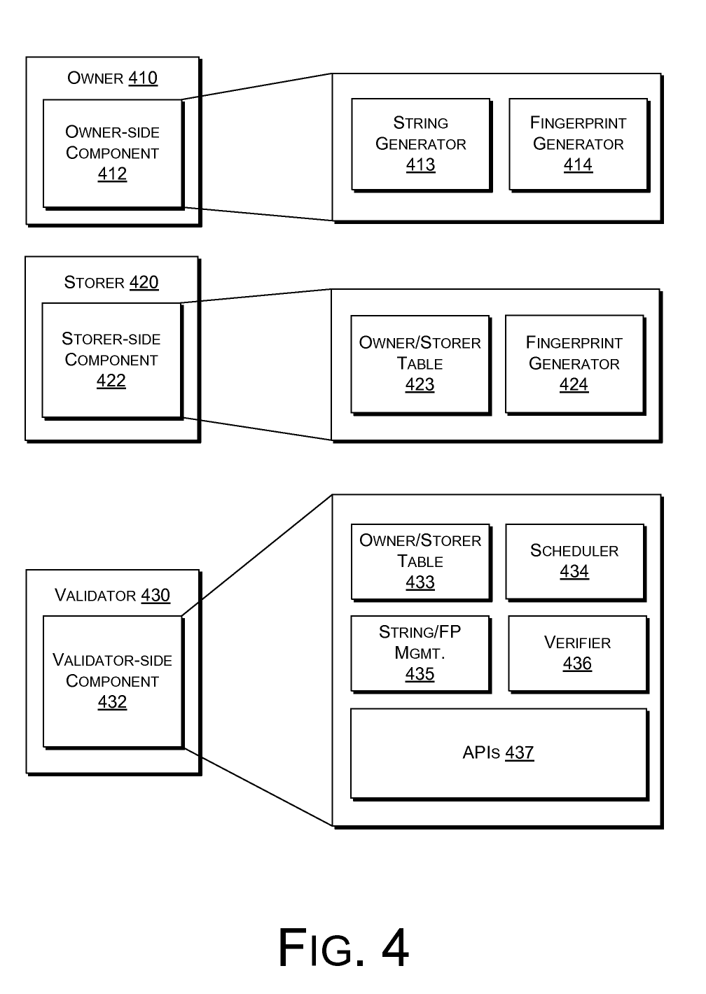

FIG. 4 shows various components for an owner 410, a storer 420 and a validator 430 (e.g., such as those shown in the system 200 of FIG. 2). The components are optionally (and typically) software components for execution on an owner-side machine, a storer-side machine, a validator-side machine, etc. As already mentioned, an owner may also operate as its own validator to validate the owner's own remote data. In such a scenario, a single machine (e.g., computing device) may include an owner component as well as various modules of a validator component. Further, an owner may operate as a storer for one or more other owners. In such a scenario, a single machine may include an owner component as well as various modules of a storer component.

The owner 410 includes an owner-side component 412 that includes a string generator module 413 and a fingerprint generator module 414. Examples of the corresponding functions for these modules have been presented above with respect to the system 200 of FIG. 2.

The storer 420 includes a storer-side component 422 that includes an owner/storer table module 423 for associating owners with stored data and a fingerprint generator module 424 for generating fingerprints in response to challenges, as already described.

The validator 430 includes a validator-side component 432 that includes an owner/storer table module 433 for associating owners with stored data, a scheduler module 434 for scheduling challenges or updates of bit strings and/or fingerprints, a string/fingerprint management module 435 for managing strings for issuing challenges and fingerprints for verifying challenges, a verification module 436 for verifying fingerprints received in response to a challenge and a set of application programming interfaces (APIs) 437 for use in any of a variety of tasks associated with validation. For example, an owner may access a validator via an API call that specifies a file, a storage location (e.g., a storer), a series of bit strings and corresponding fingerprints, a schedule for issuing challenges to a storer and contact information (e.g., an email address, etc.) to inform the owner as to whether or not a challenge was successfully completed. A validator may include an API for use by a storer in responding to a challenge. For example, after receipt of a challenge, a storer may make an API call that includes one or more fingerprints, optionally along with one or more other pieces of information germane to the stored data being verified (e.g., data accessed twice in the last three weeks, data compressed due to lack of access, data accessed by party X, etc.). In such a manner, a storer may return to a validator information that may help the data owner manage or act with respect to the data.

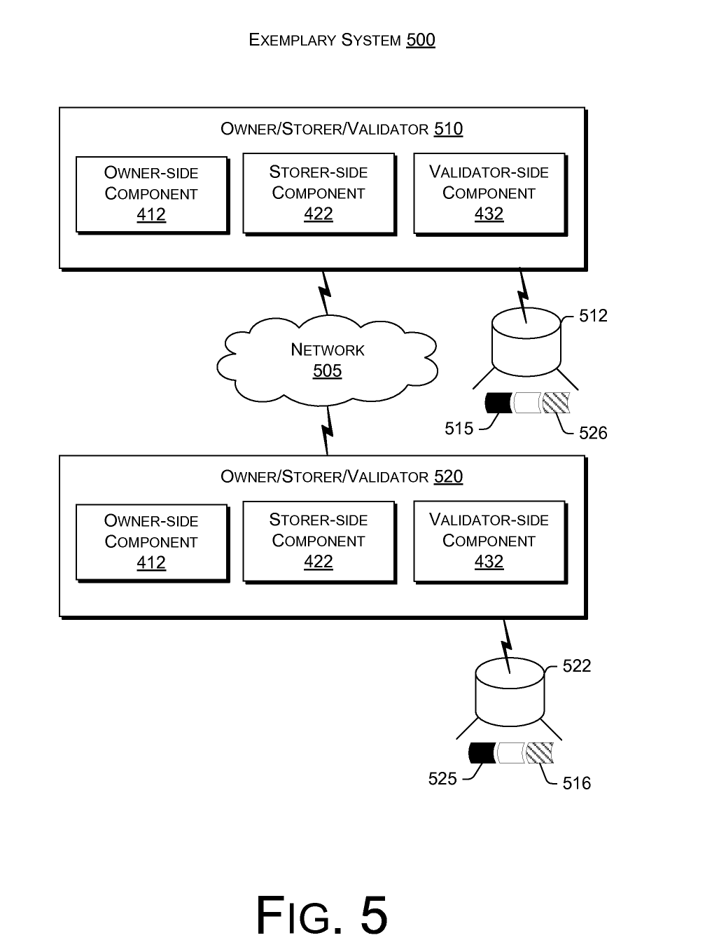

FIG. 5 shows an exemplary system 500 where two parties 510, 520, in communication via a network 505, operate cooperatively to store at least some of their data (e.g., as backup). The party 510 and the party 520 each operates using a computing device that includes an owner-side component 512, a storer-side component 522 and a validator-side component 532 such as those described with respect to FIG. 4. The party 510 has an associated data store 512 and the party 520 has an associated data store 522.

In the example of FIG. 5, the party 510 makes a copy 516 of its data 515 and sends the copy 516 to the party 520 for storage. Similarly, the party 520 makes a copy 526 of its data 525 and sends the copy 526 to the party 510 for storage. As already explained, the parties 510 and 520 can validate their remotely stored data using an exemplary protocol that relies on issuing a challenge and returning a fingerprint based at least in part on the challenge and based at least in part on the stored data to be verified.

The exemplary system 500 of FIG. 5 may be replicated for storage exchange in a peer-to-peer system. Storage exchange allows one to back up their data on other user's machines at a cost of providing some of one's disk space for others' backup data. For example, after a user “shares” 1.5 GB of her hard drive space that user is allowed to backup 1 GB of her personal files on other peers. Storage exchange can use the exemplary bit string/fingerprint protocol to ensure that peers do not delete or modify other peers' data.

In another scenario, a user may wish to store data on a remote storage service such as Amazon S3, where communication can be expensive. Use of an exemplary bit string/fingerprint protocol can help ensure that (a) the storage provider still stores the data and (b) that the storage provider didn't modify the data. As the protocol can be implemented with minimal communication, such assurances can be achieved at a very small communication cost.

As described herein, an exemplary protocol can be used to verify integrity of data stored on a remote machine. Such a protocol provides an ability to delegate verification powers to another party (e.g., a validator). In various examples, the protocol uses a fingerprint generated by applying a cryptographic hash function to stored data to verify the integrity of the data. While various examples are intended to be used in verifying remote data, an owner may wish to verify integrity of its own (e.g., locally) stored data by using a high integrity storer as a measure of integrity.

As described herein, an exemplary validator method can produce challenges and verifies the challenges. As a protocol, the sequence of interactions including the challenges and responses overcomes many issues associated with verification through transmitting copies of data (see, e.g., conventional system 100 of FIG. 1).

As described herein, an exemplary validator can be programmed to perform periodic updates. Further, a validator may schedule challenges based on historical information about a storer. For example, if a storer is known to be lacking integrity, then the validator may issue more frequent challenges. In contrast, for a storer with demonstrated integrity, the frequency of challenges may be considerably less. In general, an exemplary validator may issue periodic challenges at increasing or decreasing intervals of time, depending on the circumstances.

As described herein, an exemplary method can include scheduling issuance of challenges to check integrity of data stored by one or more parties where an issued challenge requires a challenged party (e.g., a storer that acts to remotely store the data for a data owner) to apply a keyed cryptographic hash function and adjusting an issuance frequency for a party based at least in part on the party's ability to meet one or more issued challenges (e.g., successful challenge or unsuccessful challenge). For example, the frequency may increase where a party fails to meet one or more issued challenges. Alternatively, the frequency may decrease where a party meets one or more issued challenges. Such a method may include obtaining challenge information from one or more owners of stored data, for example, where the obtaining occurs periodically and allows a data owner to provide new challenge information.

As described herein, an exemplary peer-to-peer system includes one or more computing devices configured to: store data locally where the locally stored data includes data owned by a local owner and a copy of data owned by a remote owner; to receive a key associated with the copy of data owned by the remote owner; to generate a fingerprint using the key in a keyed cryptographic hash function as applied to the copy of data owned by the remote owner; and to send the fingerprint to another computing device in the peer-to-peer system for verifying the integrity of the copy of data owned by the remote owner. In such a system, the other computing device may be configured to receive the fingerprint and to compare the fingerprint to a fingerprint generated using the key in a keyed cryptographic hash function as applied to data of known integrity owned by the remote owner.

In an exemplary peer-to-peer system one or more computing devices may be configured to generate a key and to generate a fingerprint using the key in a keyed cryptographic hash function as applied to data of known integrity. Such a computing device may be further configured to send the key and the fingerprint to one or more other computing devices in the peer-to-peer system. Further, a peer-to-peer system may include one or more schedules to schedule sending a key to one or more computing devices in the peer-to-peer system.

### Exemplary Computing Device

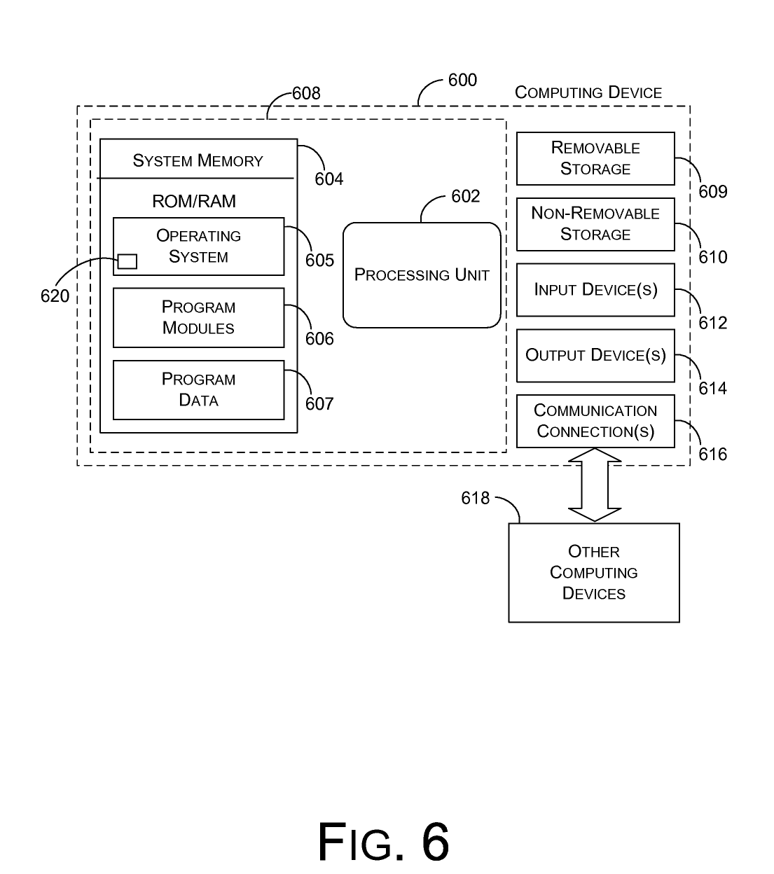

FIG. 6 illustrates an exemplary computing device 600 that may be used to implement various exemplary components and in forming an exemplary system. For example, the computing devices of the system of FIG. 2 may include various features of the device 600.

In a very basic configuration, computing device 600 typically includes at least one processing unit 602 and system memory 604. Depending on the exact configuration and type of computing device, system memory 604 may be volatile (such as RAM), non-volatile (such as ROM, flash memory, etc.) or some combination of the two. System memory 604 typically includes an operating system 605, one or more program modules 606, and may include program data 607. The operating system 605 include a component-based framework 620 that supports components (including properties and events), objects, inheritance, polymorphism, reflection, and provides an object-oriented component-based application programming interface (API), such as that of the .NET™ Framework manufactured by Microsoft Corporation, Redmond, Wash. The device 600 is of a very basic configuration demarcated by a dashed line 608. Again, a terminal may have fewer components but will interact with a computing device that may have such a basic configuration.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by removable storage 609 and non-removable storage 610. Computer storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of device 600. Computing device 600 may also have input device(s) 612 such as keyboard, mouse, pen, voice input device, touch input device, etc. Output device(s) 614 such as a display, speakers, printer, etc. may also be included. These devices are well know in the art and need not be discussed at length here.

Computing device 600 may also contain communication connections 616 that allow the device to communicate with other computing devices 618, such as over a network (e.g., consider the aforementioned network 205 of FIG. 2). Communication connections 616 are one example of communication media. Communication media may typically be embodied by computer readable instructions, data structures, program modules, etc.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for verifying the integrity of remotely stored data, the method comprising:
providing a key;
providing a fingerprint, the fingerprint generated using the key in a keyed cryptographic hash function as applied to data of known integrity;
sending the key to a remote storage location that stores a copy of the data of known integrity;
receiving a fingerprint from the remote storage location, the fingerprint generated using the key in a keyed cryptographic hash function as applied to the remotely stored copy of the data; and
verifying the integrity of the remotely stored copy of the data based at least in part on comparing the provided fingerprint to the received fingerprint.

2. The method of claim 1 wherein the key comprises a bit string.

3. The method of claim 1 wherein the key comprises a randomly generated key.

4. The method of claim 1 wherein the key comprises one of a series of keys that correspond to the data of known integrity.

5. The method of claim 1 wherein the key comprises one of a series of keys generated by applying a pseudorandom number generator to a master key.

6. The method of claim 1 wherein the provided fingerprint comprises one of a series of fingerprints that correspond to the data of known integrity.

7. The method of claim 1 wherein the provided key and the provided fingerprint are provided as a pair.

8. The method of claim 1 wherein an owner of the data of known integrity provide the key and the fingerprint.

9. The method of claim 1 wherein the sending occurs according to a schedule.

10. The method of claim 1 further comprising providing more than one key and providing more than one fingerprint wherein each provided fingerprint corresponds to one of the provided keys.

11. The method of claim 1 wherein the verifying occurs at a computing device that is provided the key, that is provided the fingerprint, that sends the key to the remote storage location, and that receives the fingerprint from the remote storage location.

12. The method of claim 1 wherein the computing device performs the verifying without receiving a copy of the remotely stored copy of the data.

13. A computing device comprising:
one or more processors;
memory to store a key and a fingerprint generated using the key in a keyed cryptographic hash function as applied to data of known integrity; and
components comprising instructions to send the key to a remote storage location that stores a copy of the data of known integrity; to receive a fingerprint from the remote storage location, the fingerprint generated using the key in a keyed cryptographic hash function as applied to the remotely stored copy of the data; and to verify the integrity of the remotely stored copy of the data based at least in part on comparing the provided fingerprint to the received fingerprint.

14. The computing device of claim 13 further comprising storage to store the data of known integrity and to generate the fingerprint using the key in a keyed cryptographic hash function as applied to the data of known integrity.

15. The computing device of claim 13 further comprising storage to remotely store data owned by another.

16. A peer-to-peer system comprising:
a computing device configured to:
store data locally wherein the locally stored data comprises data owned by a local owner and a copy of data owned by a remote owner;
to receive a key associated with the copy of data owned by the remote owner;
to generate a fingerprint using the key in a keyed cryptographic hash function as applied to the copy of data owned by the remote owner; and
to send the fingerprint to another computing device in the peer-to-peer system for verifying the integrity of the copy of data owned by the remote owner.

17. The peer-to-peer system of claim 16 wherein the other computing device is configured to receive the fingerprint and to compare the fingerprint to a fingerprint generated using the key in a keyed cryptographic hash function as applied to data of known integrity owned by the remote owner.

18. The peer-to-peer system of claim 16 wherein the copy of data owned by the remote owner comprises a backup copy.

19. The peer-to-peer system of claim 16 comprising a computing device configured to generate a key and to generate a fingerprint using the key in a keyed cryptographic hash function as applied to data of known integrity.

20. The peer-to-peer system of claim 19 wherein the computing device is further configured to send the key and the fingerprint to one or more other computing devices in the peer-to-peer system.

21. The peer-to-peer system of claim 16 further comprising a schedule to schedule sending a key to one or more computing devices in the peer-to-peer system.

22. A method, implemented at least in part by a computing device, comprising:
scheduling issuance of challenges to check integrity of data stored by one or more parties wherein an issued challenge requires a challenged party to apply a keyed cryptographic hash function and wherein the challenged party acts to remotely store the data for a data owner; and
adjusting an issuance frequency for a party based at least in part on the party's ability to meet one or more issued challenges.

23. The method of claim 22 further comprising obtaining challenge information from one or more owners of stored data.

24. The method of claim 23 wherein the obtaining occurs periodically and wherein the challenge information comprises new challenge information.
